(19) United States
(12) Patent Application Publication
(10) Pub. No.: US 2020/0187547 A1
(43) Pub. Date: Jun. 18, 2020

(54) PARTICULATE MATTER SUPPLY DEVICE

(71) Applicant: KAWASAKI JUKOGYO KABUSHIKI KAISHA, Kobe-shi, Hyogo (JP)

(72) Inventors: Yukio IWASAKI, Kobe-shi (JP); Ippei NAGAHIRO, Kobe-shi (JP); Masashi MISAWA, Kakogawa-shi (JP); Kyo DAN, Akashi-shi (JP)

(73) Assignee: KAWASAKI JUKOGYO KABUSHIKI KAISHA, Kobe-shi, Hyogo (JP)

(21) Appl. No.: 16/608,962

(22) PCT Filed: Apr. 13, 2018
(86) PCT No.: PCT/JP2018/015496

§ 371 Date: Oct. 28, 2019

(30) Foreign Application Priority Data
Apr. 26, 2017 (JP) 2017-087040

(51) Int. Cl. A23P 20/12; B65G 65/48

(52) U.S. Cl. CPC A23P 20/12; B65G 65/48

(57) ABSTRACT

A particulate matter supply device capable of suppressing leakage of particulate matter includes an accommodation region formed so as to penetrate a rotating member along a facing direction in which a spiral member and a fixing plate face each other. The spiral member includes a level-off portion that levels off particulate matter in excess of the capacity of the accommodation region when the rotating member moves from a position where the accommodation region communicates with a flow path for supplying particulate matter to the accommodation region to a position where the accommodation region communicates with a discharge port.

### TECHNICAL FIELD

The present invention relates to a particulate matter supply device that supplies particulate matter to a predetermined position.

### BACKGROUND ART

Conventionally, a particulate matter supply device for supplying predetermined amounts of particulate matter has been used. PTL 1 discloses one example of such a particulate matter supply device. PTL 1 discloses a particulate matter supply device that accommodates particulate matter in a predetermined region, and levels off particulate matter by moving a portion accommodating the particulate matter rotationally in a cylinder and causing the portion to pass below a level-off portion.

### CITATION LIST

### Patent Literature

PTL: 1 JP 2012-6687 A

### SUMMARY OF INVENTION

### Technical Problem

However, in the particulate matter supply device disclosed in PTL 1, the portion that accommodates particulate matter is partitioned by vanes that extend radially outward from a rotating body. Additionally, a gap is formed between the radially outer end of the vane that partitions the portion that accommodates the particulate matter and the inside of the cylinder. Since there is a gap between the radially outer end of the vane and the inside of the cylinder, the particulate matter may leak from the gap while moving the particulate matter. Accordingly, even if levelling off is performed, the accommodated amount of particulate matter decreases as the particulate matter leaks from the portion containing the particulate matter. Hence, the supply amount of particulate matter becomes insufficient, and it may not be possible to perform quantitative supply of the particulate matter.

In view of the above-mentioned circumstances, an objective of the present invention is to provide a particulate matter supply device that can suppress leakage of particulate matter.

### Solution to Problem

The particulate matter supply device according to the present invention includes: a first member that defines a first flow path allowing passage of particulate matter; a second member in which a second flow path allowing passage of particulate matter is formed; and a rotating member that has an accommodation region for accommodating particulate matter therein, is disposed between the first member and the second member, and is capable of moving rotationally while passing a first position where the accommodation region communicates with the first flow path and a second position where the accommodation region communicates with the second flow path, and is characterized in that the accommodation region is formed so as to penetrate the rotating member along a facing direction in which the first member and the second member face each other, and the first member is provided with a level-off portion that, when the rotating member moves from the first position to the second position, levels off an amount of particulate matter exceeding a capacity of the accommodation region.

In the particulate matter supply device described above, since the accommodation region is formed by penetrating the rotating member along the facing direction in which the first member and the second member face each other, the outside of the accommodation region is enclosed with portions forming the rotating member. Since the accommodation region is enclosed, leakage of the particulate matter from the accommodation region can be reduced when moving the accommodation region with particulate matter accommodated therein to perform levelling off. Accordingly, it is possible to precisely and quantitatively supply the particulate matter supplied through the second flow path.

Additionally, an inclined surface that is inclined as a whole toward the level-off portion may be formed in the first flow path, so that particulate matter is supplied toward the level-off portion.

Since the inclined surface that is inclined as a whole toward the level-off portion is formed in the first flow path, it is possible to efficiently supply particulate matter to the level-off portion. Since a sufficient amount of particulate matter is supplied to the level off position when performing the levelling off, it is possible to avoid shortage of particulate matter when performing the levelling off that hinders quantitative supply of particulate matter.

Additionally, the inclined surface may be formed in the first member.

Since the inclined surface is formed in the first member, the configuration of the device is simplified, and the device can be downsized.

Additionally, the level-off portion may be formed on an end of the inclined surface.

Since the level-off portion is formed on the end of the inclined surface, the inclined surface and the level-off portion can be configured integrally, and the configuration of the device can be simplified.

Additionally, the rotating member may have multiple accommodation regions.

Additionally, the first member may be disposed so as to cover the accommodation region between the level-off portion and the second flow path among the multiple accommodation regions.

Since the first member is disposed so as to cover the opening of the accommodation region between the level-off portion and the second flow path among the multiple accommodation regions, entry of the particulate matter into the levelled off accommodation region can be suppressed.

Additionally, the second flow path may be formed in the second member inside a position corresponding to the first member along the facing direction.

Since the second flow path is disposed in a position corresponding to the first member, entry of particulate matter other than the levelled off particulate matter into the second flow path can be suppressed.

Additionally, a first container portion may further be included, the first member, the second member, and the rotating member may be disposed inside the first container portion, the first member and the second member may be attached to an inside of the first container portion, and the rotating member may be disposed so as to be rotationally movable between the first member and the second member.

Since the first member, the second member, and the rotating member are disposed inside the first container portion, the device can be configured compactly. Hence, the device can be downsized.

Additionally, a second container portion having an opening may further be included, the second container portion may be connected to the first member such that the opening communicates with the first flow path, and the inclined surface may be formed inside the second container portion.

Since the inclined surface is formed inside the second container portion and the whole inclined surface is inclined toward the level-off portion, the particulate matter accommodated in the second container portion can be supplied efficiently toward the level-off portion.

Additionally, the first member, the rotating member, and the second container portion may be supported by the second member, the first member may be attached to the second member in a state where a gap is formed between the first member and the second member, and the rotating member may move rotationally while passing the first position and the second position by moving in the gap.

Since the rotating member is disposed in the gap between the first member and the second member and moves in the gap, the rotating member can be easily replaced by taking out the rotating member from the gap.

Additionally, the rotating member is replaceable according to a desired amount of particulate matter falling from the second flow path.

Since the supply amount of particulate matter falling from the second flow path can be changed by changing the rotating member, the supply amount of particulate matter can be adjusted easily.

Additionally, the rotating member is replaceable according to a desired falling position of particulate matter falling from the second flow path.

Since the falling position of particulate matter falling from the second flow path can be changed by changing the rotating member, the supply position of particulate matter can be changed easily.

A supply portion that supplies particulate matter may be configured as a hand portion of a robot.

Since the supply portion is configured as a hand portion of a robot, particulate matter can be supplied with high precision.

### Advantageous Effects of Invention

According to the present invention, it is possible to perform quantitative supply of particulate matter with higher precision, and to improve the quality of a particulate matter supply device.

### BRIEF DESCRIPTION OF DRAWINGS

FIG. 1 is a perspective view of a particulate matter supply device according to a first embodiment of the present invention.

FIG. 2 is a front view of a particulate matter supply device body portion of the particulate matter supply device of FIG. 1.

FIG. 3 is an enlarged perspective view of a supply portion of the particulate matter supply device of FIG. 1.

FIG. 4(a) is a plan view of a spiral member of the supply portion of FIG. 3 as viewed from above, FIG. 4(b) is a plan view of a rotating member as viewed from above, and FIG. 4(c) is a plan view of a fixing plate as viewed from above.

FIG. 5 is a block diagram showing a configuration of a control system of the particulate matter supply device of FIG. 1.

FIG. 6 is perspective views of the spiral member, the rotating member, and the fixing plate, showing states when the rotating member is moving in the supply portion of FIG. 3.

FIG. 7 is a perspective view showing a supply portion of a particulate matter supply device according to a second embodiment of the present invention.

FIG. 8 is an exploded perspective view showing the supply portion in order to describe the configuration of the supply portion of FIG. 7.

FIG. 9 is perspective views showing states when the rotating member is moving in the supply portion of FIG. 7.

FIG. 10 is perspective views each showing an example of the shape of an accommodation region of a rotating member which is replaced in order to change the supply of particulate matter.

### DESCRIPTION OF EMBODIMENTS

Hereinafter, a particulate matter supply device according to an embodiment of the present invention will be described with reference to the accompanying drawings.

### First Embodiment

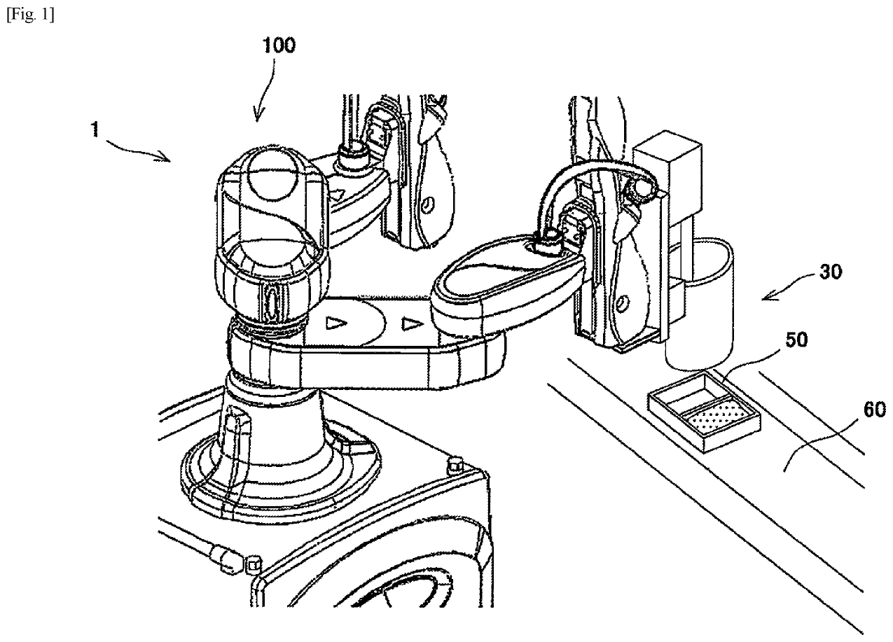

FIG. 1 shows a perspective view of a particulate matter supply device 1 according to a first embodiment of the present invention. The particulate matter supply device 1 includes a particulate matter supply device body portion 100 and a belt conveyor 60.

The belt conveyor 60 transports a box 50. The belt conveyor 60 is disposed so that the box 50 passes a position facing the particulate matter supply device body portion 100. An opening of the box 50 is opened upward.

Food is accommodated in the box 50. In the embodiment, cooked rice is accommodated in the box 50. Additionally, in the embodiment, sesame is used as the particulate matter. A fixed amount of sesame is sprinkled onto the cooked rice accommodated in the box 50 using the particulate matter supply device 1. However, the present invention is not limited to this. Other things may be used as the particulate matter. For example, food other than sesame, such as pepper and parsley processed into particulate matter, may be supplied to a supply target using the particulate matter supply device 1 of the present invention. Additionally, the particulate matter supply device 1 may be used for particulate matter other than food. Other particulate matter other than food may be used as long as the particulate matter is supplied in fixed amounts to the supply target.

Next, the configuration of the particulate matter supply device body portion 100 will be described.

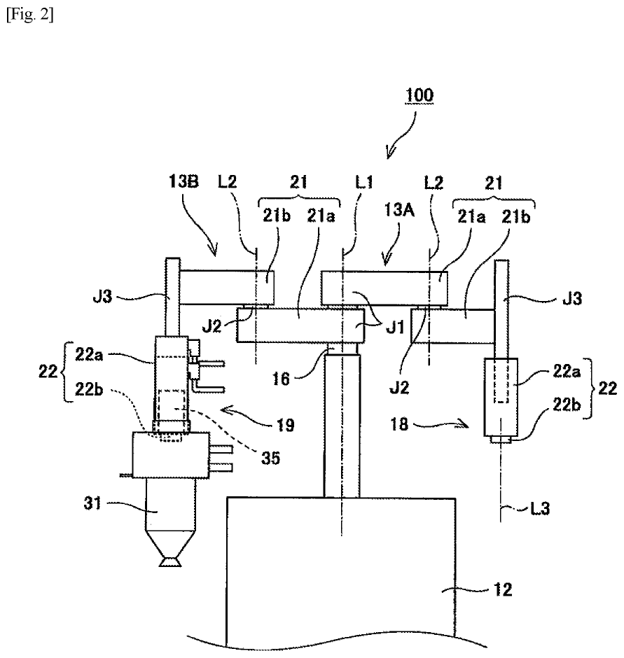

FIG. 2 shows a front view of the particulate matter supply device body portion 100 of the embodiment. As shown in FIG. 2, the particulate matter supply device body portion 100 is configured of a dual-arm selective compliance assembly robot arm (SCARA) robot including a pair of robot arms 13.

The particulate matter supply device body portion 100 includes a first robot arm 13A and a second robot arm 13B. A first holder 18 is provided on a tip end portion of the first robot arm 13A. A second holder 19 is provided on a tip end portion of the second robot arm 13B. Hereinafter, when the first robot arm 13A and the second robot arm 13B are not distinguished from each other, they are simply referred to as robot arm 13.

The particulate matter supply device body portion 100 includes a controller 14. Additionally, the particulate matter supply device body portion 100 may include a vacuum generator (not shown).

The controller 14 is provided inside a support 12 of the particulate matter supply device body portion 100, for example. However, the present invention is not limited to this, and the controller 14 may be provided inside the robot arm 13, for example. Additionally, the controller 14 may be provided in another vacant space.

The first robot arm 13A moves the first holder 18 within a predetermined operation range. Additionally, the second robot arm 13B moves the second holder 19 within a predetermined operation range. The robot arm 13 is a SCARA, for example, and includes an arm portion 21 and a wrist portion 22. Additionally, the first robot arm 13A and the second robot arm 13B can operate independently of each other or operate in conjunction with each other.

Each of the first holder 18 and the second holder 19 is capable of holding a hand portion having a function. Note that in the embodiment, the first holder 18 does not hold a hand portion, and the second holder 19 holds a later-described supply portion 30 as the hand portion.

The particulate matter supply device body portion 100 includes a support 12 and a base shaft 16 extending vertically upward from the support 12. The base shaft 16 is rotatably attached to the support 12.

The arm portion 21 is attached to the base shaft 16 so as to extend in the horizontal direction. The arm portion 21 is attached so as to be rotatable about the base shaft 16.

The arm portion 21 includes a first link 21a and a second link 21b. The first link 21a and the second link 21b are supported so as to be rotatable relative to each other along the horizontal direction. The first robot arm 13A and the second robot arm 13B are connected to the base shaft 16 through the arm portion 21.

The arm portion 21 positions the wrist portion 22 attached to the tip end portion of each of the first robot arm 13A and the second robot arm 13B in an arbitrary position within the operation range.

The first link 21a is connected at its proximal end portion to the base shaft 16 of the support 12 by a rotary joint J1, and is rotatable about a rotation axis L1 passing through the shaft center of the base shaft 16. The second link 21b is connected to a tip end portion of the first link 21a by a rotary joint J2, and is rotatable about a rotation axis L2 defined at the tip end portion of the first link 21a.

The wrist portion 22 arbitrarily changes the posture of a mechanism connected to its end. The wrist portion 22 includes an elevation portion 22a and a rotation portion 22b. The elevation portion 22a is connected to a tip end portion of the second link 21b by a linear motion joint J3, and is capable of moving up and down with respect to the second link 21b. The rotation portion 22b is connected to a lower end portion of the elevation portion 22a by a rotary joint J4, and is capable of rotating about a rotation axis L3 defined at the lower end of the elevation portion 22a.

In the embodiment, the rotation axes L1 to L3 are parallel to one another, and extend in the vertical direction, for example. Additionally, the extending direction of the rotation axes L1 to L3 and the elevation direction of the elevation portion 22a are parallel to each other.

The arm 13 is provided with a servomotor (not shown) for driving, an encoder (not shown) for detecting the rotation angle of the servomotor, and the like, in association with each of the joints J1 to J4. Additionally, the rotation axis L1 of the first robot arm 13A and the rotation axis L1 of the second robot arm 13B are on the same straight line, and the first link 21a of the first robot arm 13A and the first link 21a of the second robot arm 13B are disposed with a height difference in the up-down direction.

Next, the hand portion held by the second holder 19 will be described. The second holder 19 holds, as a hand portion, the supply portion 30 that supplies the particulate matter to the inside of the box 50.

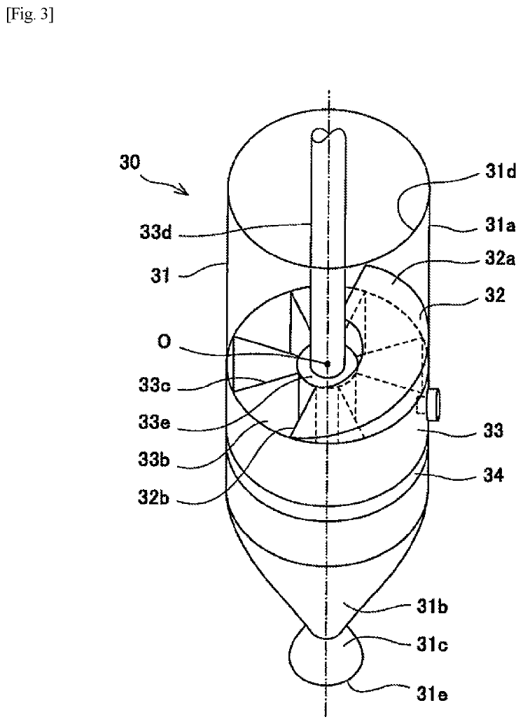

FIG. 3 shows an enlarged perspective view of the supply portion 30. In FIG. 3, a container portion 31 of the supply portion 30 is shown in a transparent manner for the sake of explanation.

The supply portion 30 will be described. The supply portion 30 includes the container portion (first container portion) 31, a spiral member (first member) 32, a rotating member 33, and a fixing plate (second member) 34.

The container portion 31 has a cylindrical portion 31a, a conical reduced diameter portion 31b whose diameter is narrowed toward the vertically lower direction, and a conical enlarged diameter portion 31c whose diameter is increased toward the vertically lower direction. An opening 31d is formed at one end of the cylindrical portion 31a. The cylindrical portion 31a and the reduced diameter portion 31b are connected at the other end of the cylindrical portion 31a.

In the embodiment, particulate matter is supplied to a later-described accommodation region 33b through the cylindrical portion 31a of the container portion 31. Accordingly, in the embodiment, the cylindrical portion 31a of the container portion 31 functions as a flow path (first flow path) for supplying the particulate matter toward the accommodation region 33b.

The reduced diameter portion 31b is connected to the enlarged diameter portion 31c at the other end of the reduced diameter portion 31b on the side opposite to the one end connected to the cylindrical portion 31a. In the enlarged diameter portion 31c, an opening 31e is formed at the other end of the enlarged diameter portion 31c on the side opposite to the one end connected to the reduced diameter portion 31b.

The spiral member 32, the rotating member 33, and the fixing plate 34 are disposed in the cylindrical portion 31a of the container portion 31.

The spiral member 32 and the fixing plate 34 are fixedly attached to the inside of the cylindrical portion 31a. Additionally, the rotating member 33 is disposed on the fixing plate 34. Hence, the rotating member 33 is disposed so as to be rotatable between the spiral member 32 and the fixing plate 34.

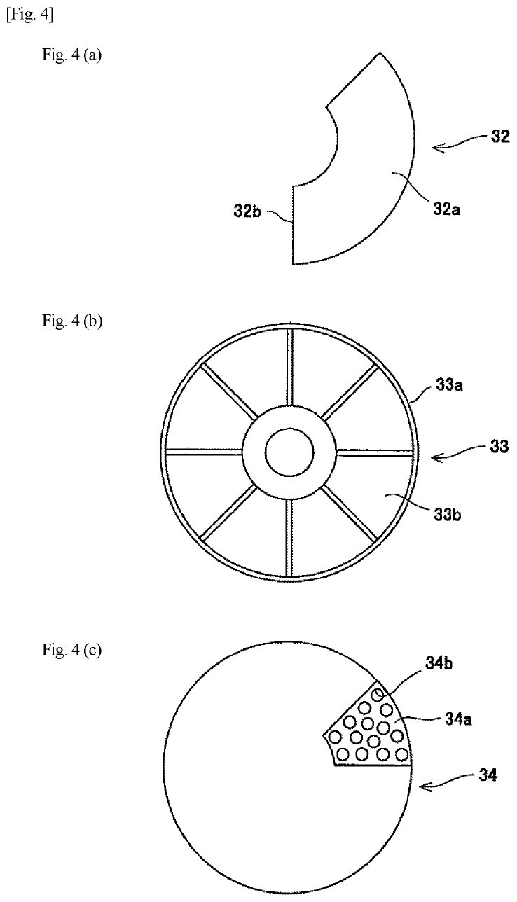

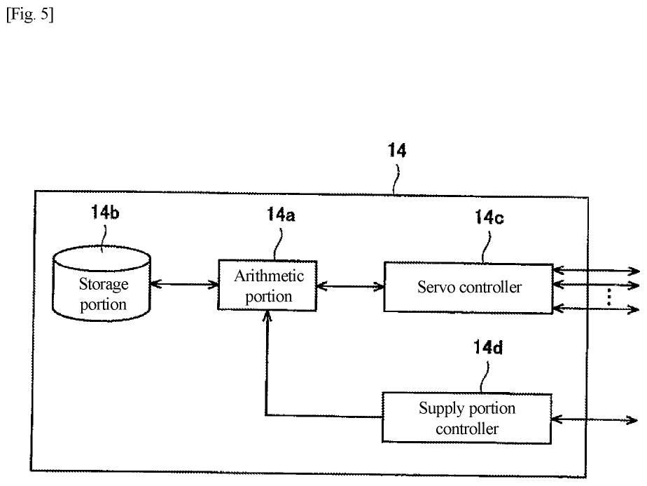

FIG. 4(a) shows a plan view of the spiral member 32 as viewed from the vertically upper direction. The spiral member 32 is formed by being defined by two curved surfaces having different distances from the radial center O of the cylindrical portion 31a in the container portion 31. Of the two curved surfaces having different distances from the radial center O of the cylindrical portion 31a, the surface in a position far from the center O is formed substantially along the shape of an inner surface of the cylindrical portion 31a. Additionally, the surface in a position close to the center O is formed substantially along the shape of an inner surface of an accommodation region of the rotating member 33.

A bottom surface of the spiral member 32 formed on the vertically lower side extends horizontally. In a vertically upper surface 32a of the spiral member 32, one end in the circumferential direction is formed in a position at the same height as the bottom surface, and the other end on the side opposite to the one end in the circumferential direction is formed in a position higher than the bottom surface. Accordingly, the vertically upper surface 32a of the spiral member 32 is formed so that one end and the other end in the circumferential direction are continuous and in a spiral shape. One circumferential end of the vertically upper surface 32a of the spiral member 32 is formed at the same height as the bottom surface, and functions as a level-off portion 32b. Additionally, the vertically upper surface 32a of the spiral member 32 partitions a flow path (first flow path) that supplies particulate matter toward the accommodation region 33b and allows passage of the particulate matter.

FIG. 4(b) shows a plan view of the rotating member 33 as viewed from the vertically upper direction.

The rotating member 33 is disposed between the spiral member 32 and the fixing plate 34. The rotating member 33 includes therein the accommodation region 33b. The rotating member 33 has a cylindrical portion 33a and a partition portion 33c that partitions the multiple accommodation regions 33b inside the cylindrical portion 33a. Additionally, an engagement portion 33e engaged with a shaft 33d and attached to the shaft 33d is formed on the inner side of the rotating member 33. The rotating member 33 and the shaft 33d are connected by the engagement between the engagement portion 33e and the shaft 33d.

The accommodation region 33b is formed to accommodate therein particulate matter. By supplying particulate matter from the upper opening with the lower opening closed by the fixing plate 34, the particulate matter can be accommodated in the accommodation region 33b.

A motor 35 is attached in an upper portion of the shaft 33d. By driving the motor 35, the shaft 33d can be rotated. Since the shaft 33d is connected to the rotating member 33, the rotating member 33 can be rotated along with rotation of the shaft 33d.

Multiple accommodation regions 33b are formed in the rotating member 33. In the embodiment, eight accommodation regions 33b are formed. The accommodation region 33b is formed so as to penetrate the rotating member 33 along a facing direction in which the spiral member 32 and the fixing plate 34 face each other. In the rotating member 33, nothing covers the accommodation region 33b in the vertical direction, and the accommodation region 33b is open toward vertically upper and lower directions. Accordingly, if there is no configuration for closing the accommodation region 33b below the rotating member 33, particulate matter that enters the accommodation region 33b from the vertically upper direction falls directly in the vertically lower direction. Additionally, since the accommodation region 33b is formed by penetrating the rotating member 33 along the facing direction in which the spiral member 32 and the fixing plate 34 face each other, the outside of the accommodation region 33b is enclosed with portions forming the rotating member 33. In the embodiment, in a cross section taken along a plane perpendicular to the axial direction of the rotation axis of the rotating member 33, the accommodation region 33b is enclosed with the cylindrical portion 33a and the partition portion 33c. That is, in the cross section taken along a plane perpendicular to the axial direction of the rotation axis of the rotating member 33, the outside of the accommodation region 33b is enclosed.

FIG. 4(c) shows a plan view of the fixing plate 34 as viewed from the vertically upper direction.

The fixing plate 34 is attached to the inside of the container portion 31. The fixing plate 34 is disposed below the rotating member 33 and is disposed so as to close the lower opening of the seven accommodation regions 33b among the eight accommodation regions 33b of the rotating member 33.

A discharge port (second flow path) 34b is formed only in a discharge area 34a corresponding to one of the eight accommodation regions 33b so as to penetrate the fixing plate 34 in the vertical direction. Many discharge ports 34b are formed in the discharge area 34a. Since the discharge port 34b penetrates the fixing plate 34 in the vertical direction, when the discharge area 34a is disposed below the accommodation region 33b, the particulate matter accommodated in the accommodation region 33b is supplied to a region below the discharge port 34b through the discharge port 34b, and is discharged to the outside from the opening 31e through the reduced diameter portion 31b and the enlarged diameter portion 31c.

The discharge port 34b is not formed in parts other than the discharge area 34a of the fixing plate 34. Hence, when a part other than the discharge area 34a of the fixing plate 34 covers the lower opening of the accommodation region 33b, the lower opening of the accommodation region 33b is closed, and the particulate matter can be accommodated in the accommodation region 33b. Additionally, particulate matter can be moved by moving the rotating member 33 with the part other than the discharge area 34a of the fixing plate 34 covering the lower opening of the accommodation region 33b. The particulate matter can be moved by moving the rotating member 33 together with the particulate matter in the accommodation region 33b, while the particulate matter is accommodated in the accommodation region 33b.

In the embodiment, particulate matter is accommodated in the accommodation region 33b after passing through the inside of the cylindrical portion 31a of the container portion 31. The flow path to the accommodation region 33b in the cylindrical portion 31a functions as a flow path (first flow path) for supplying particulate matter to the accommodation region 33b.

The rotating member 33 is capable of moving rotationally while passing a position (first position) where the accommodation region 33b communicates with the flow path for supplying particulate matter to the accommodation region 33b, and a position (second position) where the accommodation region 33b communicates with the discharge port 34b.

The spiral member 32 is provided with the level-off portion 32b that levels off particulate matter in excess of the capacity of the accommodation region 33b when the rotating member 33 moves from the position where the accommodation region 33b communicates with the flow path for supplying particulate matter to the accommodation region 33b to the position where the accommodation region 33b communicates with the discharge port 34b. The particulate matter accommodated in the accommodation region 33b is levelled off each time it passes the position directly below the level-off portion 32b by the rotational movement of the rotating member 33. In the embodiment, since the multiple accommodation regions 33b are formed over the entire circumferential direction of the rotating member 33, the particulate matter accommodated in the accommodation region 33b is levelled off each time each accommodation region 33b passes the position directly below the level-off portion 32b.

The spiral member 32 has an inclined surface that is the flow path for supplying particulate matter to the accommodation region 33b and is inclined as a whole toward the level-off portion 32b so that the particulate matter can be supplied toward the level-off portion 32b. In the embodiment, the vertically upper surface 32a of the spiral member 32 functions as the inclined surface which is inclined as a whole toward the level-off portion 32b, so that the particulate matter can be supplied toward the level-off portion 32b. Additionally, the level-off portion 32b is formed on the end of the vertically upper surface 32a of the spiral member 32.

The spiral member 32 is disposed along the circumferential direction so as to cover the accommodation regions 33b between the level-off portion 32b and the discharge port 34b among the multiple accommodation regions 33b of the rotating member 33. The discharge port 34b is formed in the fixing plate 34 inside a position corresponding to the spiral member 32 along the facing direction in which the spiral member 32 and the fixing plate 34 face each other.

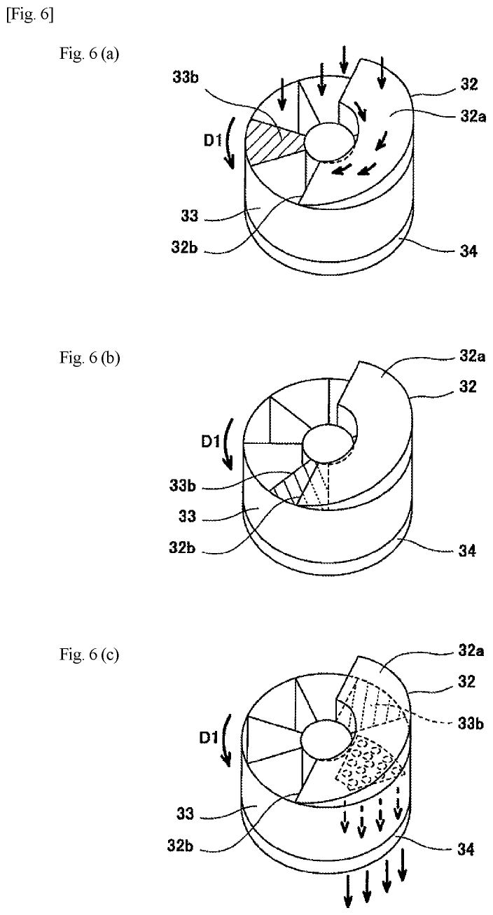

Next, the controller 14 that controls the operation of the particulate matter supply device body portion 100 will be described. FIG. 6 is a block diagram schematically showing a configuration example of a control system of the particulate matter supply device body portion 100.

As shown in FIG. 6, the controller 14 includes an arithmetic portion 14a, a storage portion 14b, a servo controller 14c, and a supply portion controller 14d.

The controller 14 is a robot controller provided with a computer such as a microcontroller, for example. Note that the controller 14 may be configured by a single controller 14 that performs centralized control, or may be configured by multiple controllers 14 that perform distributed control in cooperation with one another.

The storage portion 14b stores information such as a basic program as a robot controller and various fixed data. The arithmetic portion 14a controls various operations of the particulate matter supply device body portion 100 by reading and executing software such as the basic program stored in the storage portion 14b. That is, the arithmetic portion 14a generates a control command of the particulate matter supply device body portion 100, and outputs the control command to the servo controller 14c and the supply portion controller 14d.

The servo controller 14c is configured to control the drive of servo motors corresponding to each of the joints J1 to J4 of the first robot arm 13A and the second robot arm 13B of the particulate matter supply device body portion 100, on the basis of the control command generated by the arithmetic portion 14a.

The supply portion controller 14d controls the movement and operation of the supply portion 30 by controlling the driver on the basis of the control command generated by the arithmetic portion 14a.

A description will be given of an operation when particulate matter is supplied toward the opening of the box 50 by the particulate matter supply device 1 configured as described above.

When supplying particulate matter to the box 50, the particulate matter to be supplied to the box 50 is supplied to the inside of the container portion 31. In the embodiment, the particulate matter is supplied to the inside of the container portion 31 through the opening 31d of the container portion 31.

FIGS. 6(a) to 6(c) show a process in which the rotating member 33 is rotationally moved while particulate matter is supplied to the inside of the container portion 31. FIGS. 6(a) to 6(c) are perspective views showing states in which the accommodation region 33b is rotationally moved as the rotating member 33 is rotated in direction D1.

In FIGS. 6(a) to 6(c), the description will be given by focusing on one accommodation region 33b of the eight accommodation regions 33b. The accommodation region 33b to be focused is indicated by hatching. When particulate matter is supplied to the container portion 31, a part of the particulate matter supplied to the inside of the container portion 31 is accommodated in the accommodation region 33b, and the others is supplied onto the spiral member 32.

FIG. 6(a) shows a state in which, while the particulate matter slides and moves on the vertically upper surface 32a of the spiral member 32, particulate matter is also supplied to the inside of the accommodation region 33b.

The particulate matter supplied onto the spiral member 32 slides on the vertically upper surface 32a of the spiral member 32 and falls along the surface 32a due to gravity. The particulate matter that reaches the level-off portion 32b at one circumferential end of the vertically upper surface 32a of the spiral member 32 falls from the spiral member 32 into the accommodation region 33b. Accordingly, the particulate matter that falls onto the spiral member 32 can be efficiently guided to the inside of the accommodation region 33b by using the surface 32a as the inclined surface of the spiral member 32.

Accordingly, the particulate matter supplied to the inside of the container portion 31 is supplied toward the accommodation region 33b. At this time, the fixing plate 34 is disposed below the accommodation region 33b. Hence, the fixing plate 34 forms the bottom surface of the accommodation region 33b of the rotating member 33, and the fixing plate 34 closes the lower opening of the accommodation region 33b so that the particulate matter does not fall from the accommodation region 33b. As a result, the particulate matter accommodated in the accommodation region 33b accumulates on the fixing plate 34 without falling directly, and is accommodated in the accommodation region 33b.

The rotating member 33 rotates while the particulate matter is supplied to the inside of the container portion 31. At this time, since the rotating member 33 and the shaft 33d are connected, the shaft 33d is rotated by the rotational drive of the motor 35, and the rotating member 33 is rotated with the rotation of the shaft 33d. Thus, the rotational drive from the motor 35 is transmitted to the rotating member 33 through the shaft 33d, and the rotating member 33 is rotationally moved.

The accommodation region 33b moves rotationally along with the rotational movement of the rotating member 33. FIG. 6(b) shows a state in which the accommodation region 33b moves rotationally and is disposed in a position directly below the level-off portion 32b of the spiral member 32.

When the rotating member 33 moves rotationally in direction D1 and the accommodation region 33b moves to a position below the spiral member 32, the accommodation region 33b passes the position of the level-off portion 32b.

Since the particulate matter is continuously supplied to the inside of the accommodation region 33b, when reaching the level-off portion 32b, the particulate matter is supplied in an amount exceeding the capacity of the accommodation region 33b. Accordingly, in the accommodation region 33b, the particulate matter is filled up higher than the upper opening of the accommodation region 33b.

The accommodation region 33b passes the position directly below the level-off portion 32b in a state where the particulate matter is filled up over the upper opening of the accommodation region 33b. At this time, the particulate matter which is filled up higher than the level-off portion 32b beyond the level-off portion 32b is levelled off by the level-off portion 32b, pushed out of the accommodation region 33b, and is removed.

When the rotating member 33 further moves rotationally in direction D1, the accommodation region 33b passes the position of the level-off portion 32b, and is disposed in a position immediately below the spiral member 32. As a result, all of the particulate matter accommodated in the accommodation region 33b is levelled off, and a fixed amount of particulate matter determined by the capacity of the accommodation region 33b is accommodated in the accommodation region 33b.

When the rotating member 33 further moves rotationally and the accommodation region 33b reaches a position corresponding to the discharge area 34a of the fixing plate 34, the accommodation region 33b communicates with the discharge port 34b, and the particulate matter is discharged from the discharge port 34b.

FIG. 6(c) shows a state in which the accommodation region 33b is disposed in a position corresponding to the discharge area 34a of the fixing plate 34.

At this time, a fixed amount of particulate matter is accommodated in the accommodation region 33b after being levelled off by the level-off portion 32b. Accordingly, a fixed amount of particulate matter is discharged from the discharge port 34b. As a result, quantitative supply of particulate matter can be performed through the discharge port 34b.

The particulate matter that passes through the discharge port 34b is discharged from the opening 31e through the reduced diameter portion 31b and the enlarged diameter portion 31c of the container portion 31. Particulate matter discharged in a fixed amount from the opening 31e is supplied to the inside of the box 50 conveyed on the belt conveyor 60. As a result, a fixed amount of particulate matter is supplied toward the inside of the box 50.

According to the embodiment, since the outside of the accommodation region 33b is enclosed, leakage of particulate matter from the accommodation region 33b can be reduced when the accommodation region 33b moves with the particulate matter accommodated therein to perform levelling off. Accordingly, of the particulate matter supplied through the discharge port 34b, a fixed amount of particulate matter determined by the capacity of the accommodation region 33b is discharged. As a result, it is possible to supply a fixed amount of particulate matter through the discharge port 34b, and to perform quantitative supply of particulate matter with high precision.

Additionally, according to the embodiment, the whole vertically upper surface 32a of the spiral member 32 is inclined toward the level-off portion 32b. Accordingly, the particulate matter supplied to the inside of the container portion 31 slides on the surface 32a and moves toward the level-off portion 32b. Hence, the particulate matter supplied on the spiral member 32 moves toward the level-off portion 32b. As a result, the particulate matter can be efficiently supplied to the level-off portion 32b.

When performing levelling off by the level-off portion 32b, it is desirable that the particulate matter be filled up to a position beyond the height of the level-off portion 32b in the accommodation region 33b. If particulate matter is filled up to a position beyond the height of the level-off portion 32b, levelling off by the level-off portion 32b will allow a fixed amount of particulate matter to be accommodated in the accommodation region 33b. Accordingly, by performing the levelling off by the level-off portion 32b, the fixed amount of particulate matter is accommodated in the accommodation region 33b, and the fixed amount of particulate matter is supplied from the discharge port 34b. Hence, quantitative supply of particulate matter can be performed reliably.

If the particulate matter accommodated in the accommodation region 33b is insufficient when levelling off by the level-off portion 32b, particulate matter of only a part of the capacity is accommodated in the accommodation region 33b when levelling off is performed. Hence, even if the particulate matter in the accommodation region 33b is levelled off in this state, there is a possibility that quantitative supply of particulate matter cannot be performed with the shortage of particulate matter in the accommodation region 33b. When the particulate matter is uniformly supplied toward the multiple accommodation regions, the particulate matter is evenly supplied to the multiple accommodation regions, and there is a possibility that the particulate matter may run short in the accommodation region where levelling off is performed.

In the embodiment, the vertically upper surface 32a of the spiral member 32 is inclined toward the level-off portion 32b. Since the particulate matter supplied to the container portion 31 is supplied toward the level-off portion 32b, when levelling off by the level-off portion 32b, even if the particulate matter is insufficient in the accommodation region 33b where levelling off is not performed, there is a high possibility that the particulate matter is filled up beyond the height of the level-off portion 32b in the accommodation region 33b where levelling off is to be performed. Accordingly, by levelling off the particulate matter, quantitative supply of particulate matter can be performed more reliably.

Additionally, in the embodiment, the whole vertically upper surface 32a of the spiral member 32 is inclined toward the level-off portion 32b. Accordingly, all of the particulate matter supplied from the container portion 31 toward the accommodation region 33b is supplied without waste toward the accommodation region 33b that is not yet subjected to levelling off. Hence, it is possible to perform the levelling off by the level-off portion 32b efficiently.

Additionally, in the embodiment, since the level-off portion 32b is provided on the circumferential end of the spiral member 32, the surface 32a as the inclined surface for supplying the particulate matter to the level off position and the level-off portion 32b are formed integrally. Since the inclined surface for supplying particulate matter to the level off position the level-off portion 32b are configured by a single member, the configuration of the supply portion 30 for performing quantitative supply of particulate matter is simplified. Hence, the supply portion 30 can be downsized.

Since the configuration of the supply portion 30 can be downsized, the supply portion 30 can be configured to be suitable for a hand portion of a robot. Additionally, since the structure of the supply portion 30 can be simplified, the manufacturing cost of the supply portion 30 can be kept small.

Additionally, in the embodiment, the spiral member 32, the rotating member 33, and the fixing plate 34 are stored inside the container portion 31. Accordingly, the configuration for performing quantitative supply is stored in the container portion 31. Hence, the configuration of the supply portion 30 can be made compact. Thus, the supply portion 30 can be further downsized.

Additionally, the spiral member 32 is disposed so as to cover the opening of the accommodation region 33b, which is positioned between the level-off portion 32b and the discharge port 34b, among the multiple accommodation regions 33b. Since the spiral member 32 is disposed to cover the opening of the accommodation region 33b located between the level-off portion 32b and the discharge port 34b, it is possible to avoid entry of particulate matter into the accommodation region 33b which has been subjected to levelling off. Accordingly, it is possible to prevent additional particulate matter from entering the accommodation region 33b, which has been levelled off and accommodates a fixed amount of particulate matter, and altering the fixed amount of particulate matter accommodated in the accommodation region 33b to a different amount. Hence, the particulate matter accommodated in the accommodation region 33b is maintained in a fixed amount, and in the supply of the particulate matter to the box 50, quantitative supply of particulate matter can be performed reliably.

Additionally, the discharge port 34b is formed in the fixing plate 34 inside a position corresponding to the spiral member 32 along the facing direction in which the spiral member 32 and the fixing plate 34 face each other. That is, the discharge port 34b is disposed inside the region directly below the spiral member 32. Since the discharge port 34b is disposed in a position corresponding to the spiral member 32, the upper portion of the discharge port 34b is covered with the spiral member 32. Hence, entry of particulate matter other than the levelled off particulate matter into the discharge port 34b can be suppressed. Accordingly, in the discharge of the particulate matter from the discharge port 34b, a fixed amount of particulate matter can be discharged more reliably.

Note that in the embodiment, the first holder 18 of the particulate matter supply device body portion 100 does not hold a hand portion as an end effector, and is not involved in the supply of particulate matter. However, the present invention is not limited to this, and the first holder 18 may hold an end effector. For example, the first holder 18 may hold a guide portion that guides transport of the box 50 transported along the belt conveyor 60, such that the transported box 50 is moved and disposed to a position directly below the supply portion 30. Additionally, end effectors having other configurations may be held.

### Second Embodiment

Next, a particulate matter supply device according to a second embodiment of the present invention will be described. Note that descriptions will be omitted on parts configured similarly to the above first embodiment, and descriptions will be given only on different parts.

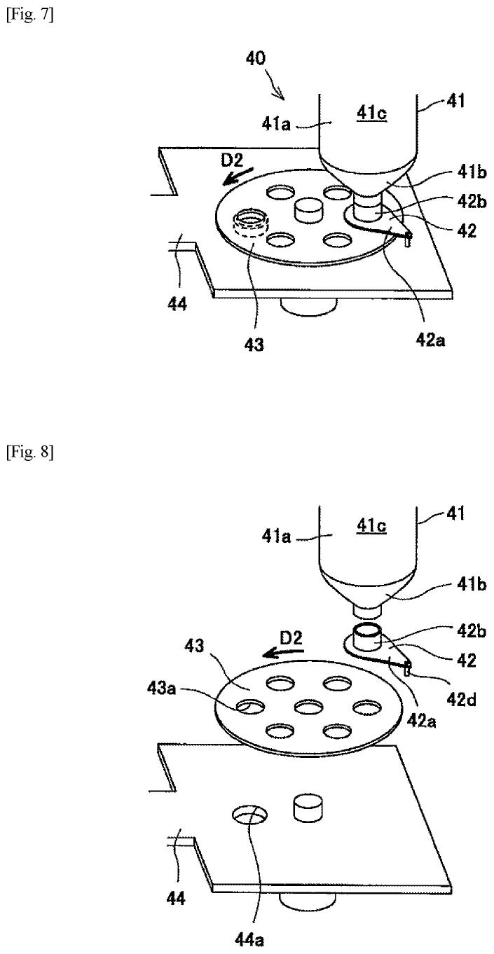

In the second embodiment, a second holder 19 includes a supply portion 40. FIG. 7 shows a perspective view of the periphery of the supply portion 40 of the particulate matter supply device according to the second embodiment. Additionally, FIG. 8 shows an exploded perspective view of a container portion 41, a level-off body 42, a rotating member 43, and a connection portion 44 of a supply portion 30.

The supply portion 40 of the second embodiment includes the container portion (second container portion) 41, a level-off portion (first member) 42 for levelling off, the rotating member 43 that moves rotationally with particulate matter accommodated inside an accommodation region to move the particulate matter to a discharge port while levelling off, and the connection portion (second member) 44 for connecting the second holder 19 and the rotating portion 43.

The second holder 19 holds the connection portion 44. The connection portion 44 is attached to the second holder 19 so as to project frontward from the second holder 19.

The container portion 41, the level-off body 42, and the rotating member 43 are disposed on the connection portion 44. The container portion 41, the level-off body 42, and the rotating member 43 are attached on the connection portion 44 such that the connection portion 44 supports the container portion 41, the level-off body 42, and the rotating member 43.

The container portion 41 has a space 41c, and is capable of supplying particulate matter to the inside of the space 41c. The container portion 41 has a cylindrical portion 41a formed in a cylindrical shape and a conical portion 41b formed in a conical shape in a position close to the level-off body 42. The conical portion 41b is connected to the level-off body 42 at a lower end portion. The conical portion 41b has an opening at its tip end portion. The container portion 41 is connected to the level-off body 42 such that the opening communicates with the flow path of particulate matter.

The level-off body 42 has a flat plate portion 42a and a cylindrical portion 42b. The plate portion 42a is fixedly attached to the connection portion 44. This fixedly attaches the level-off body 42 to the connection portion 44.

The cylindrical portion 42b is connected to the plate portion 42a. A through hole is formed in the plate portion 42a so as to penetrate the plate portion 42a in the thickness direction. The cylindrical portion 42b and the plate portion 42a are connected in a position surrounding the through hole. Additionally, the cylindrical portion 42b and the plate portion 42a are connected so that an inner wall surface of the cylindrical portion 42b is continuous with a side surface of the plate portion 42a surrounding the through hole. The inner wall surface of the cylindrical portion 42b and the through hole in the plate portion 42a are formed so as to penetrate the level-off body 42, and function as a flow path (first flow path) that allows passage of particulate matter. The particulate matter is supplied from the container portion 41 through the level-off body 42 to an accommodation region 43a of the rotating member 43 through the flow path. The container portion 41 and the level-off body 42 are connected such that the space inside the container portion 41 communicates with an inner wall surface of the cylindrical portion 42b of the level-off body 42 and the through hole in the plate portion 42a. Since the container portion 41 is connected to the level-off body 42 so that the internal space communicates with the flow path that allows the particulate matter to pass through to the accommodation region 43a, the particulate matter can be continuously supplied to the flow path by feeding the particulate matter into the internal space of the container portion 41.

A gap is formed between the level-off body 42 and the connection portion 44, and the rotating member 43, the connection portion 44, and the level-off body 42 are configured so that the rotating member 43 can be positioned in the gap. Hence, the level-off body 42 is attached in a position where there is a gap between the level-off body 42 and the connection portion 44. In the embodiment, the level-off body 42 is attached to the connection portion 44 in a state in which a columnar member 42d is sandwiched between the level-off body 42 and the connection portion 44.

The rotating member 43 is disposed between the level-off body 42 and the connection portion 44. The rotating member 43 has the accommodation region 43a that penetrates the rotating member 43 in a facing direction in which the level-off portion and the connection portion 44 face each other and can accommodate the particulate matter therein. The accommodation region 43a is formed so as to penetrate the rotating member 43 along a facing direction in which the level-off body 42 and the connection portion 44 face each other. In the embodiment, six accommodation regions 43a are formed in the rotating member 43. Additionally, the rotating member 43 is configured to be rotationally movable along the horizontal direction on the surface of the connection portion 44 between the level-off body 42 and the connection portion 44. Since the rotating member 43 is disposed in the gap between the level-off body 42 and the connection portion 44 and is rotationally moved within the gap, the rotating member 43 can be easily replaced by taking out the rotating member 43 from the gap.

Additionally, since the accommodation region 43a is formed by penetrating the rotating member 43 along the facing direction in which the level-off body 42 and the connection portion 44 face each other, the outside of the accommodation region 43a is enclosed with portions forming the rotating member 43. In the rotating member 43, in the cross section taken along a plane perpendicular to the axial direction of the rotation axis of the rotating member 43, the outside of the accommodation region 43a is enclosed.

By moving rotationally in direction D2, the rotating member 43 is rotationally movable in one direction in a continuous manner while passing both of a position (first position) where the accommodation region 43a communicates with the through hole in the level-off body 42, and a position (second position) where the accommodation region 43a communicates with a discharge port 44a.

The discharge port (second flow path) 44a as a through hole is formed in the connection portion 44 so as to penetrate the connection portion 44. The discharge port 44a is formed so as to allow passage of particulate matter.

The level-off body 42 levels off particulate matter in excess of the capacity of the accommodation region 43a when the rotating member 43 moves from the position where the accommodation region 43a communicates with the through hole in the level-off body 42 to the position where the accommodation region 43a communicates with the discharge port 44a. In the embodiment, the inner wall surface of the plate portion 42a that defines the flow path of particulate matter in the level-off body 42 functions as a level-off portion that performs levelling off. An inclined surface that is inclined as a whole toward the level-off portion is formed so that the particulate matter can be supplied toward the level-off portion in the flow path of the particulate matter from the container portion 41 to the accommodation region 43a. In the embodiment, the inner wall surface of the conical portion 41b of the container portion 41 is configured as an inclined surface that is inclined toward the level-off portion. Thus, in the embodiment, the inclined surface is formed inside the container portion 41.

A driver 45 is disposed in a position on the side of the connection portion 44 opposite to the side on which the level-off body 42, the rotating member 43, and the container portion 41 are attached. The driver 45 is connected to the rotating member 43. By driving the driver 45, the rotating member 43 moves rotationally along direction D2.

When the particulate matter is supplied to the inside of the box 50 by the supply portion 40 configured as described above, the particulate matter is first supplied to the inside of the container portion 41. When the particulate matter is supplied to the inside of the container portion 41, the particulate matter falls due to gravity, and the particulate matter is supplied to the inside of the accommodation region 43a formed in the plate portion 43b of the rotating member 43 through the cylindrical portion 42b and the through hole in the plate portion 42a of the level-off body 42.

When the particulate matter is supplied, the particulate matter overflows from the accommodation region 43a over the entire upper opening of the accommodation region 43a, and the particulate matter is filled up to a position higher than the upper opening of the accommodation region 43a. In this state, it is possible to level off the particulate matter in the accommodation region 43a.

When levelling off the particulate matter in the accommodation region 43a, the rotating member 43 is moved in direction D2 while the particulate matter is filled in the accommodation region 43a. When moving the rotating member 43, the driver 45 is driven to rotate the rotating member 43.

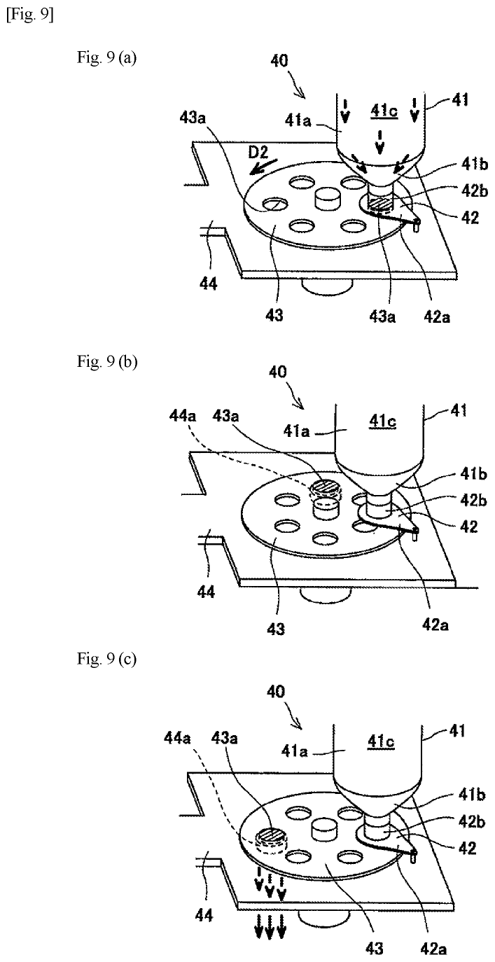

FIGS. 9(a) to 9(c) show perspective views of states in which the accommodation region 43a is filled with particulate matter, the rotating member 43 is moved, and the particulate matter accommodated in the accommodation region 43a is discharged from the discharge port 44a. In FIGS. 9(a) to 9(c), too, the description will be given by focusing on one accommodation region 43a of the six accommodation regions 43a. The accommodation region 43a to be focused is indicated by hatching.

FIG. 9(a) shows a state in which the accommodation region 43a to be focused is disposed in a position (first position) in communication with the container portion 41, and particulate matter is supplied into the accommodation region 43a.

Since the lower end portion of the conical portion 41b of the container portion 41 is connected to the cylindrical portion 42b of the level-off body 42, the particulate matter supplied to the container portion 41 falls downward toward the level-off body 42. Since the portion of the container portion 41 connected to the level-off body 42 is the conical portion 41b formed in a conical shape, the inner wall surface of the container portion 41 is formed such that its diameter is narrowed toward the lower side. Accordingly, when the particulate matter accommodated in the container portion 41 is supplied toward the accommodation region 43a, the particulate matter is supplied toward the level-off portion of the level-off body 42 where levelling off is performed. That is, the particulate matter accommodated in the container portion 41 moves toward the level-off portion of the level-off body 42 which performs levelling off.

The particulate matter that moves toward the portion of the level-off body 42 which performs levelling off is accommodated in the accommodation region 43a after passing through the level-off body 42. As a result, the particulate matter is filled in the accommodation region 43a.

When the particulate matter is filled in the accommodation region 43a, the rotating member 43 moves rotationally in direction D2, and the accommodation region 43a moves rotationally. When the accommodation region 43a moves in the state where the accommodation region 43a is filled with particulate matter, the accommodation region 43a passes a position below the level-off body 42 while holding the particulate matter in the accommodation region 43a.

At this time, the particulate matter filled in the accommodation region 43a is levelled off by the cylindrical portion 42b and the through hole in the plate portion 42a of the level-off body 42. While particulate matter is accommodated in the accommodation region 43a so as to be filled up higher than the upper opening of the accommodation region 43a, the rotating member 43 moves rotationally and the accommodation region 43a passes a position below the level-off body 42.

At this time, a portion of the particulate matter which is filled up higher than the upper opening of the accommodation region 43a is pushed out by the inner wall surface of the level-off body 42, and is removed from the accommodation region 43a. Accordingly, when the accommodation region 43a passes the position below the level-off body 42, the accommodation region 43a is filled with a fixed amount of particulate matter determined by the capacity of the accommodation region 43a. As a result, the particulate matter accommodated in the accommodation region 43a is levelled off.

When the accommodation region 43a passes the position below the level-off body 42, the accommodation region 43a moves with the rotational movement of the rotating member 43 in a state where the accommodation region 43a is filled with a fixed amount of particulate matter.

FIG. 9(b) is a perspective view of a state in which the accommodation region 43a filled with a fixed amount of particulate matter after being subjected to levelling off is disposed in a position between the level-off body 42 and the discharge port 44a.

When the accommodation region 43a accommodating a fixed amount of particulate matter moves further from the state shown in FIG. 9(b), the accommodation region 43a reaches a position above the discharge port 44a.

FIG. 9(c) shows a perspective view of a state in which the accommodation region 43a accommodating a fixed amount of particulate matter has reached the position above the discharge port 44a. When the accommodation region 43a accommodating a fixed amount of particulate matter reaches the position above the discharge port 44a, the space inside the accommodation region 43a communicates with the space inside the discharge port 44a (second position). Accordingly, the particulate matter accommodated in the accommodation region 43a falls below the discharge port 44a through the discharge port 44a. Since the particulate matter accommodated in the accommodation region 43a accommodating the fixed amount of particulate matter is discharged from the discharge port 44a, the fixed amount of particulate matter is discharged from the discharge port 44a. As a result, it is possible to supply a fixed amount of particulate matter from the discharge port 44a, and to perform quantitative supply of particulate matter through the discharge port 44a.

In this manner, the level-off body 42 levels off particulate matter in excess of the capacity of the accommodation region 43a when the rotating member 43 moves from the position where the accommodation region 43a communicates with the container portion 41 to the position where the accommodation region 43a communicates with the discharge port 44a.

According to the embodiment, since the outside of the accommodation region 43a is enclosed, leakage of the particulate matter can be reduced when moving the accommodation region 43a with particulate matter accommodated therein to perform levelling off. Accordingly, it is possible to precisely and quantitatively supply the particulate matter supplied through the discharge port 44a.

Additionally, according to the embodiment, since the inner wall surface of the container portion 41 is inclined toward the level-off portion of the level-off body 42 where the levelling off is performed by the conical portion 41b, the particulate matter accommodated in the container portion 41 is filled toward the level-off portion of the level-off body 42 which performs levelling off. Accordingly, the particulate matter is efficiently supplied toward the accommodation region 43a to be levelled off among the multiple accommodation regions 43a.

Since the particulate matter accommodated in the container portion 41 is efficiently supplied toward the accommodation region 43a to be levelled off, when levelling off is performed by the level-off body 42, the particulate matter is sufficiently filled inside the accommodation region 43a.

When scraping is performed by the level-off body 42, it is desirable that the particulate matter be filled up to a position beyond the height of the surface to be levelled off by the level-off body 42 in the accommodation region 43a. If the particulate matter is filled up to a position beyond the height of the surface to be levelled off by the level-off body 42, when levelling off is performed by the level-off body 42, a fixed amount of particulate matter is accommodated in the accommodation region 43a. Accordingly, when levelling off with the level-off body 42, it is desirable that a sufficient amount of particulate matter be accommodated inside the accommodation region 43a. As a result, by levelling off the particulate matter, quantitative supply of particulate matter can be performed more reliably. In the embodiment, since the particulate matter accommodated in the container portion 41 is efficiently supplied toward the accommodation region 43a, quantitative supply of particulate matter can be performed more reliably.

Additionally, according to the embodiment, since the rotating member 43 is formed in the gap between the level-off body 42 and the connection portion 44, the rotating member 43 can be removed relatively easily. Additionally, the rotating member 43 can be attached to the connection portion 44 relatively easily. Hence, the rotating member 43 can be replaced easily.

Since the rotating member 43 can be removed easily, the periphery of the level-off body 42 can be cleaned easily. Accordingly, the supply portion 40 with a favorable maintainability can be provided.

Additionally, in the embodiment, when fixed amounts of particulate matter are supplied toward the inside of the box 50, the supply amount of the particulate matter is determined by the shape of the accommodation region 43a formed in the rotating member 43. In the embodiment, by selecting the rotating member 43 having the accommodation region 43a of an appropriate supply amount according to the desired supply amount, particulate matter of the desired supply amount can be supplied.

In the embodiment, since the rotating member 43 can be replaced easily, it is easy to replace the rotating member 43 to that with an accommodation region 43a according to the desired supply amount. As described above, it is possible to change the rotating member 43 according to the desired amount of particulate matter falling from the discharge port 44a. Since the supply amount of particulate matter can be changed by changing the rotating member 43, the supply amount of particulate matter can be adjusted easily.

Additionally, by changing the accommodation region, it is possible to adjust the supply position of particulate matter when the particulate matter is supplied to the inside of the box 50. It is possible to change the rotating member 43 according to the desired falling position of particulate matter falling from the discharge port 44a. Since the falling position of particulate matter falling from the discharge port 44a can be changed by changing the rotating member 43, the supply position of particulate matter can be changed easily.

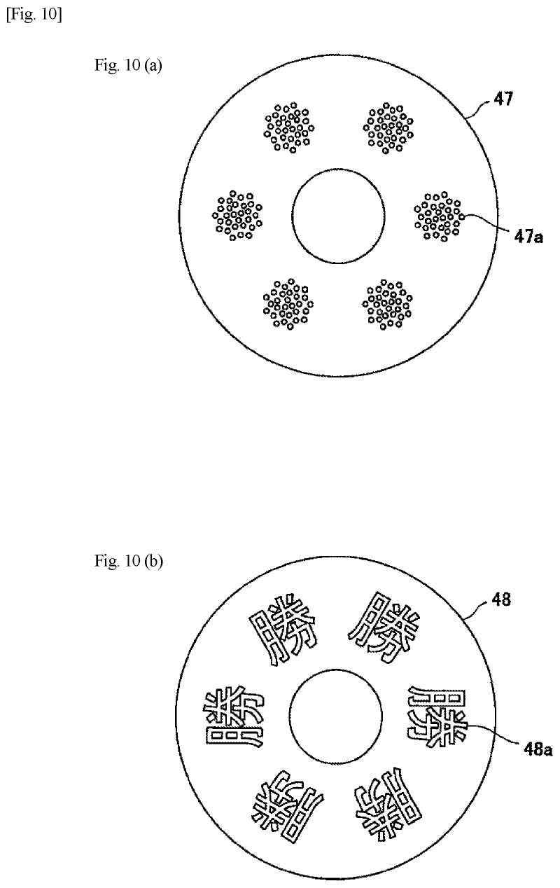

FIGS. 10(a) and 10(b) are perspective views showing the accommodation region when the shape of the accommodation region is changed in order to adjust the supply position of particulate matter. FIG. 10(a) shows a plan view of a rotating member 47 in which an accommodation region 47a is formed concentrically, so that the particulate matter is supplied to the inside of the box 50 along the shape of the concentric circles.

As shown in FIG. 10(a), since the accommodation region 47a is formed concentrically, the particulate matter discharged from the discharge port 44a and supplied to the inside of the box 50 is supplied so as to draw concentric circles inside the box 50. Thus, a pattern of a desired shape can be formed by particulate matter inside the box 50, and an enjoyable appearance can be presented inside the box 50.

Additionally, as shown in FIG. 10(b), the accommodation region can be formed in a character shape, and the particulate matter supplied to the inside of the box 50 can be supplied along the shape of the character. FIG. 10(b) shows a plan view of a rotating member 48 when the accommodation region 48a is formed along the shape of “katsu”, for example, as an example of the character.

Thus, since particulate matter can be supplied to the inside of the box 50 along the shape of a character, an enjoyable appearance can be presented inside the box 50. Additionally, it becomes possible to leave a message inside the box 50 with particulate matter. As a result, a message can be transmitted to a person who picks up the box 50 after the box 50 has been distributed to the market, for example.

Note that while the particulate matter supply device according to the second embodiment has been described as a form using a plate portion of the rotating member having an accommodation region suitable for the desired supply amount or supply position of particulate matter, the present invention is not limited to this. A plate portion of the rotating member having an accommodation region suitable for the desired supply amount or supply position of particulate matter may be selected and used in the particulate matter supply device of the first embodiment as well. Additionally, a plate portion of the rotating member having an accommodation region suitable for the desired supply amount or supply position of particulate matter may be selected and used in the particulate matter supply device of other embodiments as well.

Additionally, in the embodiment, since the rotating member 43 can be replaced easily, a desired rotating member 43 can be attached according not only to the supply amount but also to the supply position of particulate matter such as a pattern or character. Accordingly, rotating member 43 can be attached easily according to the desired supply amount or shape, and a user-friendly particulate matter supply device can be provided.

### REFERENCE SIGNS LIST

30 supply portion
32 spiral member
32b level-off portion
33 rotating member
33b accommodation region
34 fixing plate
100 particulate matter supply device body portion

1. A particulate matter supply device comprising:
a first member that defines a first flow path allowing passage of particulate matter;
a second member in which a second flow path allowing passage of particulate matter is formed; and
a rotating member that has an accommodation region for accommodating particulate matter in the accommodation region, is disposed between the first member and the second member, and is capable of moving rotationally while passing a first position where the accommodation region communicates with the first flow path and a second position where the accommodation region communicates with the second flow path, wherein
the accommodation region is formed so as to penetrate the rotating member along a facing direction in which the first member and the second member face each other, and
the first member is provided with a level-off portion that, when the rotating member moves from the first position to the second position, levels off an amount of particulate matter exceeding a capacity of the accommodation region.

2. The particulate matter supply device according to claim 1, wherein
an inclined surface that is inclined as a whole toward the level-off portion is formed in the first flow path, so that particulate matter is supplied toward the level-off portion.

3. The particulate matter supply device according to claim 2, wherein
the inclined surface is formed in the first member.

4. The particulate matter supply device according to claim 2, wherein
the level-off portion is formed on an end of the inclined surface.

5. The particulate matter supply device according to claim 1, wherein
the rotating member has a plurality of the accommodation regions.

6. The particulate matter supply device according to claim 5, wherein
the first member is disposed so as to cover the accommodation regions between the level-off portion and the second flow path among the plurality of accommodation regions.

7. The particulate matter supply device according to claim 1 wherein
the second flow path is formed in the second member inside a position corresponding to the first member along the facing direction.

8. The particulate matter supply device according to claim 1 further comprising a first container portion, wherein:
the first member, the second member, and the rotating member are disposed inside the first container portion;
the first member and the second member are attached to an inside of the first container portion; and
the rotating member is disposed so as to be rotationally movable between the first member and the second member.

9. The particulate matter supply device according to claim 2 further comprising a second container portion having an opening, wherein
the second container portion is connected to the first member such that the opening communicates with the first flow path, and
the inclined surface is formed inside the second container portion.

10. The particulate matter supply device according to claim 9, wherein:
the first member, the rotating member, and the second container portion are supported by the second member;
the first member is attached to the second member in a state where a gap is formed between the first member and the second member; and
the rotating member moves rotationally while passing the first position and the second position by moving in the gap.

11. The particulate matter supply device according to claim 1, wherein
the rotating member is replaceable according to a desired amount of particulate matter falling from the second flow path.

12. The particulate matter supply device according to claim 1, wherein
the rotating member is replaceable according to a desired falling position of particulate matter falling from the second flow path.

13. The particulate matter supply device according to claim 1, wherein
a supply portion that supplies particulate matter is configured as a hand portion of a robot.
